(19) United States
(12) Patent Application Publication
(10) Pub. No.: US 2005/0190829 A1
(43) Pub. Date: Sep. 1, 2005

(54) Phase calibrating apparatus and method thereof

(75) Inventors: Wen-Shih Lu, Banciao City (TW); John-San Yang, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Airoha Technology Corp.

(21) Appl. No.: 11/067,033

(22) Filed: Feb. 25, 2005

(30) Foreign Application Priority Data
Feb. 27, 2004 (TW) 93105224

(51) Int. Cl. H04Q 1/20

(52) U.S. Cl. 375/224

(57) ABSTRACT

A phase calibrating apparatus applied in a mixer includes a signal generator outputting a first signal and a second signal. The first signal has a phase differing by a phase value from the second signal. The phase calibrating apparatus is used to adjust the phase value to a predetermined value. The phase calibrating apparatus includes a multiplication unit and a comparator/controller unit. The multiplication unit has a multiplication of the first signal and the second signal to output a DC value corresponding to the phase value. The comparator/controller unit compares the DC value with a reference value and outputs a control signal. The signal generator adjusts the phase value according to the control signal until the phase value is substantially equal to the predetermined value.

This application claims the benefit of Taiwan application Serial No. 93105224 filed Feb. 27, 2004, the subject matter of which is incorporated herein by reference.

### BACKGROUND OF THE INVENTION

1. Field of the Invention

The invention relates in general to a phase calibrating apparatus and the method thereof, and more particularly to a phase calibrating apparatus applied in a mixer and the method thereof.

2. Description of the Related Art

Radio communication system uses a radio frequency receiver/transmitter to receive and transmit radio signal. An ordinary radio frequency receiver/transmitter so that the signal can achieve maximum volume transmission under particular circumstances.

Quadrature phase shift keying (QPSK) modulation is a commonly used phase modulating technique, whose design of using quadrature carrier signal of different phases to modulate data can transmit two bits at a time, thus enhancing the data rate of a radio system. The QPSK modulation signal includes two parts: in-phase signal and quadrature signal. After moderation, the in-phase signal and the quadrature signal are quadrature, mutual independent and without interference. A radio frequency receiver is exemplified below.

Referring to FIG. 1A, a simplified circuits diagram of a conventional radio frequency receiver is shown. The radio frequency receiver 100 includes a demodulator 110 and a digital signal processing (DSP) unit 120. As disclosed above, the input signal Si (t) received by the radio frequency receiver 100 includes two parts: in-phase modulation signal SI (t) and quadrature modulation signal SQ (t). The input signal Si are filtered and amplified to generate signal Si′, which are divided into two paths (I and Q) and outputted to a mixer 130. The mixer 130 includes a multiplier 132 located on I-path, a multiplier 134 located on Q-path, a local oscillator 136 and a phase shifter 138. The local oscillator 136 uses a phase shifter 138 to respectively output in-phase local oscillating signal ΦI and quadrature local oscillating signal ΦQ whose phase value differ by 90 degrees.

After having been wave-mixed by the multiplier 132 and the in-phase local oscillating signal ΦI, and processed by a low-pass filter 140, the signal Si′ inputted via the I-path will output the in-phase signal SI (t). On the other hand, after having been wave-mixed by the multiplier 134 and the quadrature local oscillating signal ΦQ, and processed by a low-pass filter 150, the signal Si′ inputted via the Q-path will output the quadrature signal SQ (t). After the analog/digital conversion, the in-phase signal SI (t) and the quadrature signal SQ (t) are respectively inputted to the DSP unit 120 for subsequent digital signal processing.

Besides, in terms of the modulator as shown in FIG. 1B, analog signals Si and Sq outputted by a DSP unit 160, which are respectively inputted to a modulator 170 via the I-path and the Q-path, are wave-filtered to form analog signals Si′ and Sq′, which are respectively outputted to the multipliers 132 and 134 of the mixer 130 for wave-mixing. The analog signal Si′ and the above-disclosed in-phase local oscillating signal ΦI are wave-mixed to form an in-phase signal SI; while the analog signal Sq′ and the above-disclosed quadrature local oscillating signal ΦI are wave-mixed to form a quadrature signal SQ. The in-phase and the quadrature signals SI and SQ are added, amplified, and wave-filtered to output a modulation signal So.

However, due to the difference in manufacturing process, the in-phase local oscillating signal ΦI and the quadrature local oscillating signal ΦQ, which are outputted by the local oscillator 136 and the phase shifter 138, might have errors rather than the precise 90 degrees in the phase difference value with regard to practical design of the mixer. Therefore, the in-phase signal SI (t) and the quadrature signal SQ (t) generated by the I-path and the Q-path will not match, and will correspond to a stellar diagram of QPSK modulation shown in FIG. 1C and result in distortion. In the stellar diagram, a “□” is a basis point for received bits when demodulating signals under ideal conditions, while a “x” is a phase error whose basis point is biased even in the absence of interferences and noises, not only increasing bit error rate (BER) but also reducing the efficiency of signal transmission.

Conventional phase calibrating method according to prior art is incorporated with the above-disclosed DSP unit 120 and a few testing signals to evaluate the bias of the demodulator 110. Then, either perform calibration at the DSP unit 120 before leaving the factory or connect an indicator to an output terminal of the modulator 170 for detecting and resending the outputted modulation signal So to the DSP unit 160 as phase compensation.

However, using the DSP unit for phase calibrating will increase the level of complication in the design of the DSP unit. Due to an additional indicator and the re-design of DSP unit, the DSP unit will have more elements, occupy a larger space, consume more power and take a longer time for calibration.

### SUMMARY OF THE INVENTION

It is therefore an object of the invention to provide a phase calibrating apparatus and the method thereof, which can be installed in a mixer for the comparison between a DC value, the product of the in-phase and the quadrature local oscillating signal, and the reference value. The method performs successive approximation algorithm according to the result of comparison to obtain a phase bias of modulating the mixer by the control signal without adding extra circuit to the DSP unit, not only simplifying the phase calibrating circuit but also enhancing the efficiency of phase calibrating.

According to the object of the invention, a phase calibrating apparatus applied in a mixer is provided. The mixer includes a signal generator for outputting a first signal and a second signal. The phase difference between the first signal and the second signal is a phase value. The phase calibrating apparatus is for modulating the phase value to a pre-determined value. The phase calibrating apparatus includes a multiplication unit and a comparator/controller unit. The multiplication unit is for possessing a multiplication of the first signal and the second signal to obtain a DC value corresponding to the phase value. The comparator/controller unit is for outputting a signal according to the comparison between the DC value and the reference value. The signal generator modulates the phase value according to the signal, so that the phase value is substantially equal to the pre-determined value.

The multiplication unit includes a multiplier and a sample/hold unit. The multiplier is for possessing a multiplication of the first signal and the second signal. The sample/hold unit is for sampling and holding the output of the multiplier so as to output the DC value.

The comparator/controller unit includes a comparer, a successive approximation register (SAR) unit and a digital/analog converter (DAC). The comparer is for comparing the DC value and the reference value and outputs the comparison value accordingly. When the phase value is equal to the pre-determined value, the DC value is substantially equal to the reference value. The SAR unit is for performing successive approximation algorithm according to the comparison value to output a digital signal. When the comparison value is renewed, the SAR unit re-modulates the value of the digital signal according to the renewed comparison value. The DAC converts the digital signal into the above-mentioned signal to control the signal generator. The SAR unit includes a control circuit and a SAR. The SAR is for storing the digital signal, while the control circuit is for modulating the digital signal according to the comparison value. Having the phase calibrating apparatus installed on the mixer directly simplifies the phase calibrating circuit.

According to the object of the invention, a mixer for processing an in-phase signal and a quadrature signal is provided. The mixer includes a signal generator, a first multiplier, a second multiplier and a phase calibrating apparatus. The signal generator is for outputting the first signal and the second signal. The phase difference between the first signal and the second signal is a phase value. The first multiplier receives the first signal and processes the wave-mixing routine of the in-phase signal, while the second multiplier receives the second signal and processes the wave-mixing routine of the quadrature signal. The phase calibrating apparatus is for modulating the phase value to the pre-determined value. The phase calibrating apparatus includes a multiplication unit and a comparator/controller unit. The multiplication unit is for possessing a multiplication of the first signal and the second signal to obtain a DC value corresponding to the phase value. The comparator/controller unit is for outputting a signal according to the comparison between the DC value and the reference value. The signal generator modulates the phase value according to the signal, so that the phase value is substantially equal to the pre-determined value.

The signal generator includes a local oscillator and a phase shifter, wherein the local oscillator uses the phase shifter to output a first signal and a second signal. The multiplication unit includes a multiplier and a sample/hold unit. The multiplier is for possessing a multiplication of the first signal and the second signal, while the sample/hold unit is for sampling and holding the output of the multiplier so as to output the DC value.

The mixer is applied in a demodulator, wherein the demodulator receives a modulation signal. The first signal inputted into the first multiplier is multiplied by the modulation signal to output an in-phase signal. The second signal inputted into the second multiplier is multiplied by the modulation signal to output a quadrature signal. The mixer can also be applied in the modulator. The modulation signal outputted by the modulator is equal to the addition of the output of the first multiplier and the second multiplier. The first multiplier receives the first signal and in-phase signal, while the second multiplier receives the second signal and quadrature signal. Having the phase calibrating apparatus directly installed on the mixer saves the complicated circuit test required in a conventional DSP unit.

According to another object of the invention, a phase calibrating method is provided. The method includes the steps disclosed below. Firstly, possess a multiplication of the first signal and the second signal to obtain a DC value corresponding to the phase value. Next, compare the DC value with the reference value to obtain a comparison value. Lastly, obtain a signal for modulating phase value according to the comparison value. Repeat the above steps until the phase value is substantially equal to the pre-determined value.

Of which, the step of obtaining a signal according to the comparison value further includes: possessing the successive approximation algorithm to obtain a digital signal according to the comparison value, re-modulating the value of the digital signal when the comparison value is renewed, and converting the digital signal into an analog signal to control the signal generator and modulate the phase value.

When the DC value is larger than the reference value, modulate the digital signal along the first direction to change the corresponding analog signal, furthermore, the signal generator modulates the phase value according to the analog signal to reduce the DC value. When the DC value is smaller than the reference value, modulate the digital signal along the second direction to change the corresponding analog signal, furthermore, the signal generator modulates the phase value according to the analog signal to enlarge the DC value. Possessing phase calibrating of the signal generator directly inside the mixer helps to increase the efficiency of phase calibrating.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a simplified circuits diagram of a conventional radio frequency receiver;

FIG. 1B is a circuit diagram of the mixer of FIG. 1A applied in a modulator;

FIG. 1C is a QPSK modulation stellar diagram of FIG. 1A and FIG. 1B;

FIG. 2A is a circuit diagram of the mixer applied in a demodulator according to a preferred embodiment of the invention;

FIG. 2B is a circuit diagram of the phase calibrating apparatus of FIG. 2A;

FIG. 3 is a flowchart of the phase calibrating method according to a preferred embodiment of the invention; and

FIG. 4 is a schematic diagram showing the DC value D outputted by the multiplication unit of FIG. 2B is compared with the reference value Vref to modulate the digital signal Sd and the Δ/φ value.

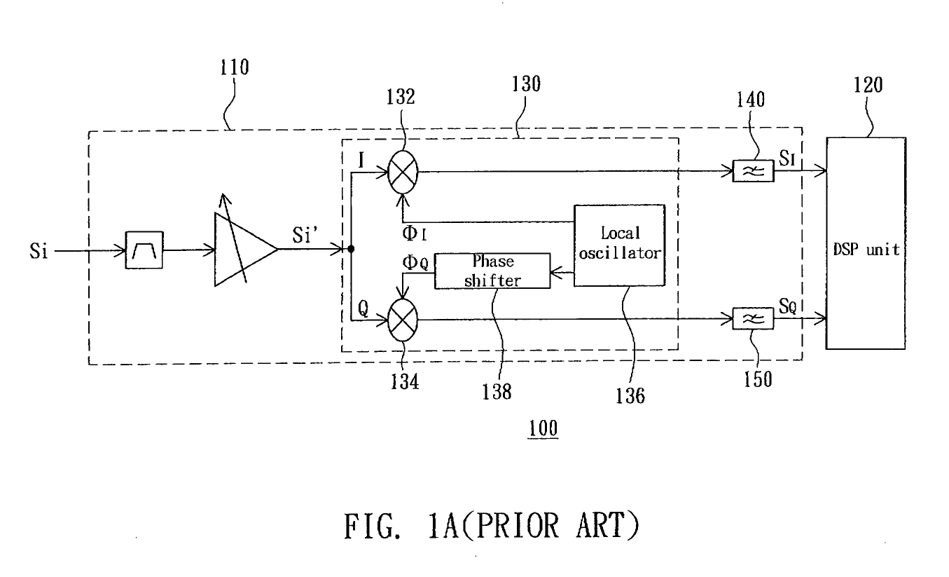

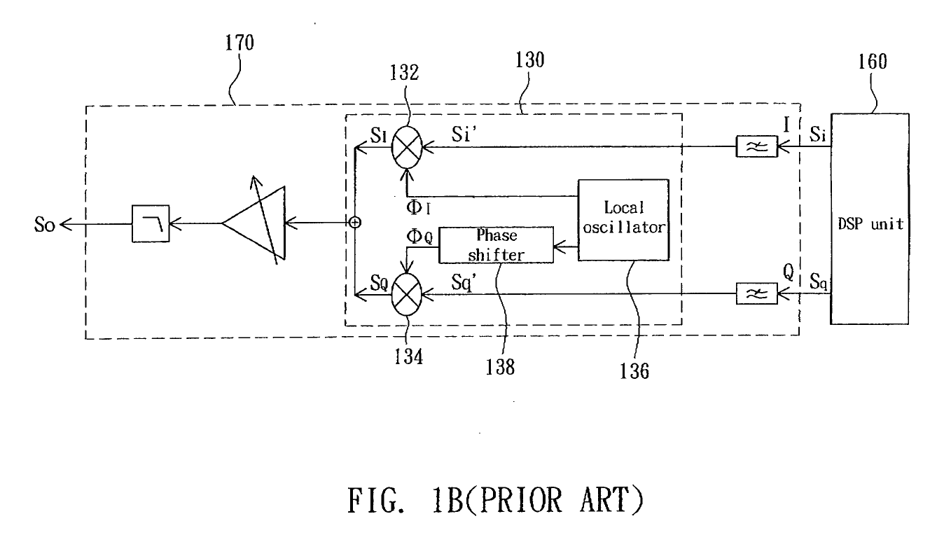

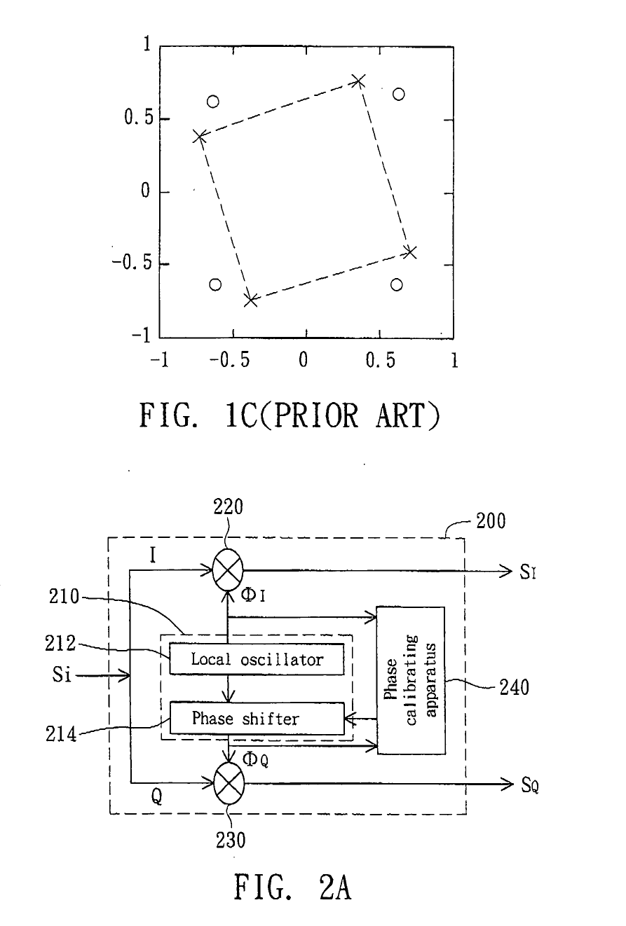

### DETAILED DESCRIPTION OF THE INVENTION

The main feature of the phase calibrating apparatus according to the invention lies in directly installing a self-compensation circuit inside the demodulator or the modulator to modulate the phase bias of the local oscillating signal outputted by the local oscillator without using the DSP unit as an extra circuit of control, not only simplifying the calibrating process but also enhancing the efficiency of phase calibrating.

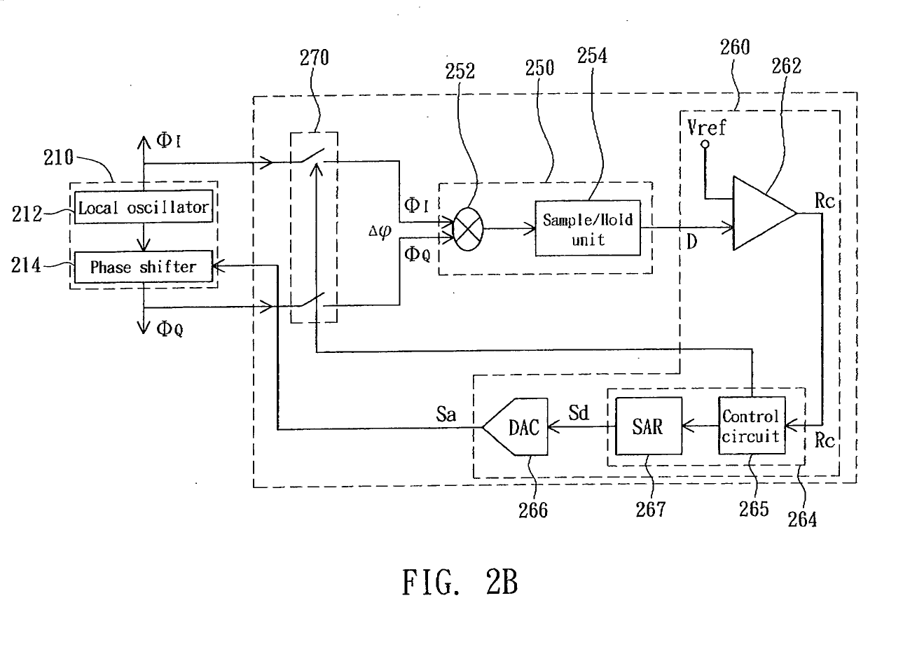

Referring to FIG. 2A, a circuit diagram of the mixer applied in a demodulator according to a preferred embodiment of the invention is shown. The mixer 200 is for possessing wave-mixing demodulation of the modulation signal Si to output an in-phase signal SI and a quadrature signal SQ. The mixer 200 includes a signal generator 210, a first multiplier 220, a second multiplier 230 and a phase calibrating apparatus 240. The signal generator 210 includes a local oscillator 212 and a phase shifter 214, wherein the local oscillator 212 uses the phase shifter 214 to output the first local oscillating signal ΦI and the second local oscillating signal ΦQ, wherein the phase difference between the local oscillating signal ΦI and ΦQ is Δφ, and the Δφ value is predetermined to be 90 degrees. The first multiplier 220 is disposed on I-path for receiving the first local oscillating signal ΦI and possessing the wave-mixing of the modulation signal Si to output a basic-frequency in-phase signal SI. The second multiplier 230 is disposed on Q-path for receiving the second local oscillating signal ΦQ and possessing wave-mixing of the modulation signal Si to output a basic-frequency quadrature signal SQ. The phase calibrating apparatus 240 is for modulating the phase difference Δφ value to the pre-determined value of 90 degrees.

Referring to FIG. 2B, a circuit diagram of the phase calibrating apparatus of FIG. 2A. The phase calibrating apparatus 240 includes the multiplication unit 250 and comparator/controller unit 260. The multiplication unit 250 includes the multiplier 252 and sample/hold unit 254. The multiplier 252 is for possessing a multiplication of the first local oscillating signal ΦI and the second local oscillating signal ΦQ, while the sample/hold unit 254 is for sampling and holding the output of the multiplier 252 to output a DC value D corresponding to the Δφ value. When the Δφ value is equal to 90 degrees, the DC value D is substantially equal to 0. The comparator/controller unit 260 is for outputting a signal Sa to the signal generator 210 according to the comparison between the DC value D and the reference value Vref, wherein the reference value Vref is equal to 0. The signal generator 210 modulates the phase difference Δφ value according to signal Sa, so that the Δφ value is substantially equal to the pre-determined value of 90 degrees.

Besides, the comparator/controller unit 260 further includes a comparer 262, an SAR unit 264 and a DAC 266. The comparer 262 is for comparing the DC value D with the reference value Vref and outputs the comparison value Rc accordingly. When the DC value D is larger than the reference value Vref, the comparison value Rc is equal to 1; whereas when the DC value D is smaller than the reference value Vref, the comparison value Rc is equal to 0. The SAR unit 264 is for performing a successive approximation algorithm according to the comparison value Rc (1/0) to output a digital signal Sd. The SAR unit 264 further includes a control circuit 265 and an SAR 267. The SAR 267 is for storing the digital signal Sd, while the control circuit 265 is for modulating the digital signal Sd according to the comparison value Rc. The DAC 266 is for converting the digital signal Sd into the analog signal Sa to control the signal generator 210.

Besides, the phase calibrating apparatus 240 further includes a switch unit 270, which is controlled by the control circuit 265 and is used for controlling the input into the multiplication unit 250 from the first local oscillating signal ΦI and the second local oscillating signal ΦQ. When the phase calibrating apparatus 240 possesses phase calibrating of the signal generator 210, the switch unit 270 will be conducted, enabling the first local oscillating signal ΦI and the second local oscillating signal ΦQ to be inputted into the multiplication unit 250. When the phase calibrating apparatus 240 completes calibtating, the switch unit 270 will not be conducted, disabling the first local oscillating signal ΦI and the second local oscillating signal ΦQ to be inputted into the multiplication unit 250, lest the phase calibrating apparatus 240 might affect the subsequent operations of the mixer 200.

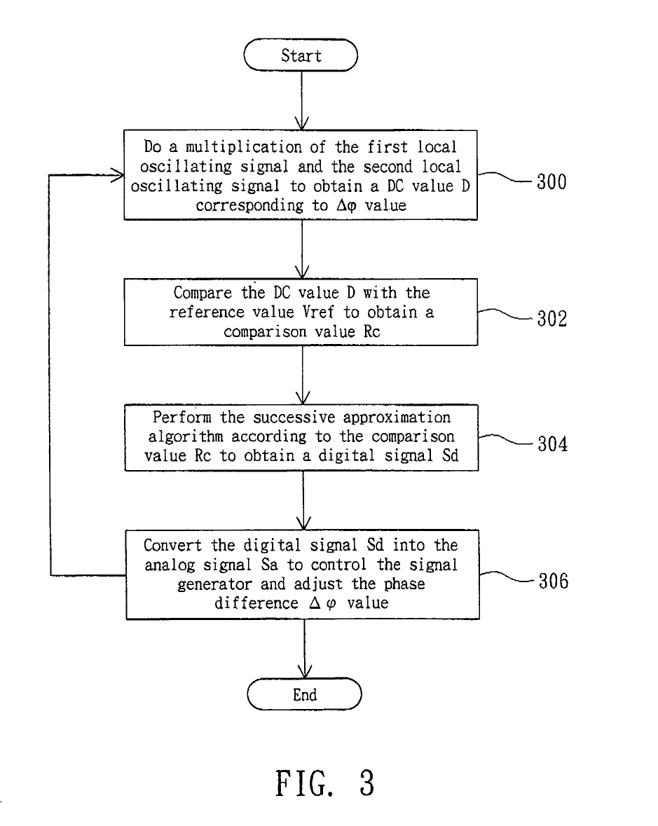

Referring to FIG. 3, a flowchart of the phase calibrating method according to a preferred embodiment of the invention is shown. Firstly, the method begins at step 300: possessing a multiplication of the first local oscillating signal ΦI and the second local oscillating signal ΦQ to obtain a DC value D corresponding to a Δφ value. Let ΦI (t)=A1 sin wt, ΦQ (t)=A2 sin (wt+Δφ), wherein w=2πf, f is the local oscillating signal frequency. The product of the multiplication of the local oscillating signal ΦI and ΦQ is equal to cos Δφ/2-cos 2 (wt+Δφ)/2. If the second part is a high-frequency signal, its DC value is equal to 0, and only the first part cos Δφ/2 will be left, i.e., the DC value D. Therefore, when the Δφ value is equal to 90 degrees, the DC value D will be equal to 0; when the Δφ value is larger than 90 degrees, the DC value D will be smaller than 0; when the Δφ value is smaller than 90 degrees, the DC value D will be larger than 0.

Next, proceed to step 302: comparing the DC value D with the reference value Verve (=0) to obtain a comparison value Rc. When the DC value D is larger than 0, Rc will be equal to a logical value 1, whereas when the DC value D is smaller than 0, Rc will be equal to a logical value 0. After that, proceed to step 304: performing the successive approximation algorithm according to the comparison value Rc (1/0) to obtain a digital signal Sd. Lastly, proceed to step 306: converting the digital signal Sd into the analog signal Sa to control the signal generator 210 and adjust the phase difference Δφ value. Repeat the step 300 until the Δφ value is substantially equal to the pre-determined value 90 degrees.

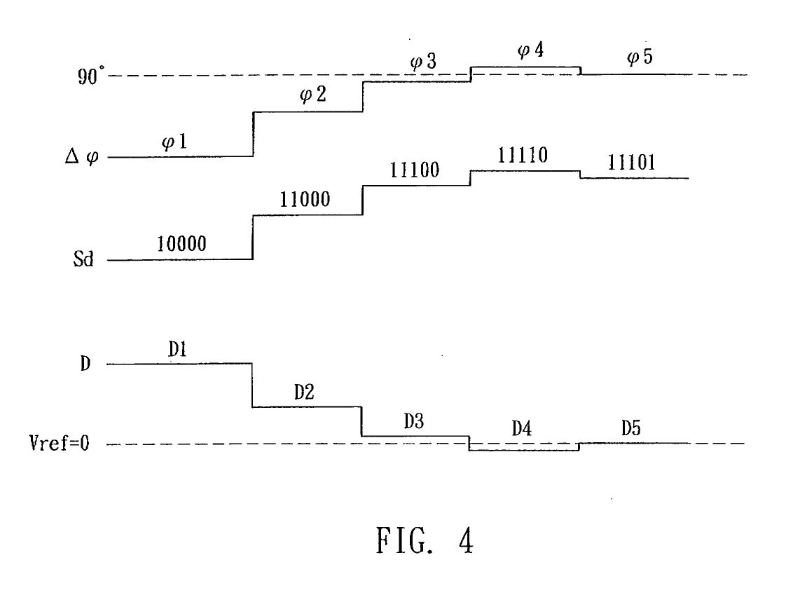

Referring to FIG. 4, a schematic diagram showing the DC value D outputted by the multiplication unit 250 of FIG. 2B is compared with the reference value Vref (=0) to modulate the digital signal Sd and the Δφ value is shown. The above digital signal control of the SAR unit 264 is exemplified by 5 bits. According to the successive approximation algorithm, the most significant bit (MSB) of the initial value of the digital signal Sd is set be 1, while the remaining bits are set t be 0, i.e., the signal Sd is set to be 10000 (=16). If the initial DC value D1 outputted by the multiplication unit 250 is larger than the reference value Vref, this means that the Δφ value (=φ1) is smaller than 90 degrees. The SAR unit 262, according to the comparison value Rc=1, maintains the MSB to be 1, and set the subsequent second effective bit to be 1, i.e., the outputted digital signal Sd is adjusted to be 11000 (=24), implying an enlarge in the digital signal Sd. So the corresponding analog signal Sa is also adjusted, the signal generator 210 is controlled to increase by Δφ value and become φ2.

Next, possess a multiplication of the first local oscillating signal ΦI and the second local oscillating signal ΦQ to obtain a DC value D2 corresponding to the φ2 value. If the DC value D2 is still larger than the reference value Vref, this means that the φ2 value is still smaller than 90 degrees (but is closer to 90 degrees than the φ1 value). The SAR unit 262, according to the comparison value Rc=1, maintains the second effective bit to be 1, and set the subsequent third effective bit to be 1. That is to say, the outputted digital signal Sd is adjusted to be 11100 (=28). So the corresponding analog signal Sa is also adjusted, the signal generator 210 is controlled to increase by Δφ value and become φ3. If the DC value D3 corresponding to the φ3 value is still larger than the reference value Vref, this means that the φ3 value is still smaller than 90 degrees (but is closer to 90 degrees than φ2 value). The SAR unit 262 maintains the third effective bit to be 1, and set the subsequent fourth effective bit to be 1. That is to say, the digital signal Sd is adjusted to be 11110 (=30), the signal generator 210 is controlled to increase by Δφ value and become φ4.

If the DC value D4 corresponding to the φ4 value is smaller than the reference value Vref, this means that the φ4 value is larger than 90 degrees (but is closer to 90 degrees than the φ3 value). So the SAR unit 264 sets the fourth effective bit to be 0, and sets the lease significant bit (LSB) to be 1. That is to say, the digital signal Sd is adjusted to be 11101 (=29), and the signal generator 210, which is controlled to reduce by Δφ value and become φ5, is closer to 90 degrees than the φ4 value. Therefore, according to the above successive approximation algorithm, the DC value Ds, from D1 to D5, gradually equals to the reference value Vref. Likewise, the value of the phase difference Δφ, from φ1 to φ5, also gradually equals to the pre-determined value 90 degrees to achieve of object of calibrating the phase bias of the local oscillating signal of the mixer 200.

Although the phase calibrating method according to the invention is exemplified by the successive approximation algorithm, the invention is not limited thereto. The invention can be applied to any method, which, according to the comparison between the DC value D and the reference value Vref, gradually modulates the phase difference Δφ value to be equal to 90 degrees.

The advantages of the phase calibrating apparatus according to the preferred embodiment of the invention disclosed above lies in directly installing a self-compensation circuit inside the demodulator or the modulator to modulate the phase bias of the local oscillating signal outputted by the local oscillator. The phase calibrating apparatus is switched on and linked for calibrating when the mixer is started, but is switched off on the completion of calibrating. No extra circuit is added to the DSP unit for detecting and controlling purpose, so the phase calibrating circuit is simplified and the operation efficiency of phase calibrating is improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A phase calibrating apparatus applied in a mixer, the mixer comprising a signal generator for outputting a first signal and a second signal, a phase value being phase difference between the first signal and the second signal, the phase calibrating apparatus for adjusting the phase value adjust to a pre-determined value, the phase calibrating apparatus comprising:
a multiplication unit for processing a multiplication of the first signal and the second signal to obtain a DC value corresponding to the phase value; and
a comparator/controller unit for outputting a signal according to the comparison between the DC value and a reference value, the signal generator adjusts the phase value according to the signal so that the phase value is substantially equal to the pre-determined value.

2. The phase calibrating apparatus according to claim 1, wherein when the DC value is larger than the reference value, the comparator/controller unit adjusts the signal along the first direction and the signal generator adjusts the phase value according to the signal to reduce the DC value, whereas when the DC value is smaller than the reference value, the comparator/controller unit adjusts the signal along the second direction and the signal generator adjusts the phase value according to the signal to enlarge the DC value.

3. The phase calibrating apparatus according to claim 1, wherein when the DC value is substantially equal to the reference value, the phase calibrating apparatus completes calibrating.

4. The phase calibrating apparatus according to claim 1, wherein the comparator/controller unit comprises:
a comparer for comparing the DC value and the reference value and outputting a comparison value, wherein when the phase value is the pre-determined value, the DC value is substantially equal to the reference value;
a successive approximation register (SAR) unit for performing the successive approximation algorithm according to the comparison value to output a digital signal, when the comparison value is renewed, the SAR unit re-adjusts the value of the digital signal according to the renewed comparison value; and
converting the digital signal into the signal for controlling the signal generator by a digital/analog (DAC) converter.

5. The phase calibrating apparatus according to claim 4, the SAR unit comprises a control circuit and a SAR, wherein the SAR is for storing the digital signal, while the control circuit is for modulating the digital signal according to the comparison value.

6. The phase calibrating apparatus according to claim 4, wherein when the DC value is larger than the reference value, the comparison value is 1, whereas when the DC value is smaller than the reference value, the comparison value is 0.

7. The phase calibrating apparatus according to claim 1, the multiplication unit comprises a multiplier and a sample/hold unit, wherein the multiplier is for possessing a multiplication of the first signal and the second signal, while the sample/hold unit is for sampling and holding the output of the multiplier to output the DC value.

8. The phase calibrating apparatus according to claim 1, wherein the pre-determined value is 90 degrees, while the reference value is 0.

9. The phase calibrating apparatus according to claim 1, wherein the mixer is applied in a radio receiver/transmitter.

10. A mixer for processing an in-phase signal and a quadrature signal, the mixer comprises:
a signal generator for outputting a first signal and a second signal, a phase value being phase difference between the first signal and the second signal;
a first multiplier for receiving the first signal and processing the wave-mixing routine of the in-phase signal;
a second multiplier for receiving the second signal and processing the wave-mixing routine of the quadrature signal; and
a phase calibrating apparatus for modulating the phase value to a pre-determined value, wherein the phase calibrating apparatus comprises:
a multiplication unit for processing a multiplication of the first signal and the second signal to obtain a DC value corresponding to the phase value;
a comparator/controller unit for outputting a signal according to the comparison between the DC value and a reference value, wherein the signal generator adjusts the phase value according to the signal, so that the phase value is substantially equal to the pre-determined value.

11. The mixer according to claim 10, wherein when the DC value is larger than the reference value, the comparator/controller unit enables the signal generator to adjust the phase value so that the DC value is reduced, when the DC value is smaller than the reference value, the comparator/controller unit enables the signal generator to adjust the phase value so that the DC value is enlarge, and when the DC value is substantially equal to the reference value, the mixer completes calibrating.

12. The mixer according to claim 10, the signal generator comprises a local oscillator and a phase shifter, wherein the local oscillator uses the phase shifter to output the first signal and the second signal.

13. The mixer according to claim 10, the multiplication unit comprises a multiplier and a sample/hold unit, wherein the multiplier is for possessing a multiplication of the first signal and the second signal, while the sample/hold unit is for sampling and holding the output of the multiplier to output the DC value.

14. The mixer according to claim 10, wherein the mixer is applied in a demodulator, which receives a modulation signal, of which, the first signal inputted into the first multiplier is multiplied by the modulation signal to output an in-phase signal, while the second signal inputted into the second multiplier is multiplied by the modulation signal to output a quadrature signal.

15. The mixer according to claim 10, wherein the mixer is applied in a modulator, a modulation signal outputted by the modulator is the addition of the output of the first multiplier and the second multiplier, the first multiplier receives input from the first signal and the in-phase signal, while the second multiplier receives input from the second signal and the quadrature signal.

16. A phase calibrating method applied in a mixer, the mixer comprising a signal generator for outputting a first signal and a second signal, a phase value being phase difference between the first signal and the second signal, the phase calibrating method for adjusting the phase value to a pre-determined value, the phase calibrating method comprising:
processing a multiplication of the first signal and the second signal to obtain a DC value corresponding to the phase value;
comparing the DC value with a reference value to obtain a comparison value; and
obtaining a signal for adjusting the phase value according to the comparison value and repeating the above steps until the phase value is substantially equal to the pre-determined value.

17. The phase calibrating method according to claim 16, wherein when the DC value is larger than the reference value adjust the signal along the first direction and adjust the phase value according to the signal the signal generator so as to reduce the DC value, when the DC value is smaller than the reference value adjust the signal along the second direction and adjust the phase value the signal generator according to the signal so as to enlarge the DC value, when the DC value is substantially equal to the reference value the phase calibrating is completed.

18. The phase calibrating method according to claim 17, wherein when the phase value is the pre-determined value, the DC value is substantially equal to the reference value.

19. The phase calibrating method according to claim 16, wherein the step of obtaining the signal according to the comparison value further comprises:
performing the successive approximation algorithm according to the comparison value to obtain a digital signal, and adjusting the value of the digital signal when the comparison value is renewed; and
converting the digital signal into an analog signal to control the signal generator and adjust the phase value.

20. The phase calibrating method according to claim 19, wherein when the DC value is larger than the reference value adjust the digital signal along the first direction so as to change the corresponding analog signal, the signal generator adjusts the phase value according to the analog signal to reduce the DC value, whereas when the DC value is smaller than the reference value adjust the digital signal along the second direction so as to change the corresponding analog signal, the signal generator adjusts the phase value according to the analog signal to enlarge the DC value.

21. The phase calibrating method according to claim 20, wherein adjusting the digital signal along the first direction is to enlarge the digital signal, while adjusting the digital signal along the second direction is to reduce the digital signal.

22. The phase calibrating method according to claim 16, wherein when the DC value is larger than the reference value the comparison value is 1, whereas when the DC value is smaller than the reference value the comparison value is 0.

23. The phase calibrating method according to claim 16, wherein the pre-determined value is 90 degrees, the reference value is 0.
